(19) United States
(12) Patent Application Publication
(10) Pub. No.: US 2026/0008631 A1
(43) Pub. Date: Jan. 8, 2026

(54) APPARATUS AND METHOD FOR SEPARATING BATCHES OF TRANSPORTED PLASTIC PREFORMS

(71) Applicant: KRONES AG, Neutraubling (DE)

(72) Inventors: Jochen FORSTHOEVEL, Regensburg (DE); Dieter WUENSCHE, Straubing (DE); Markus SIGLER, Koefering (DE); Johann ECKL, Straubing (DE)

(21) Appl. No.: 19/257,932

(22) Filed: Jul. 2, 2025

(30) Foreign Application Priority Data
Jul. 2, 2024 (DE) 10 2024 118 666.6

(51) Int. Cl. B65G 47/24; B29C 49/42; B29L 31/00; B65G 37/00; B65G 47/82

(52) U.S. Cl. CPC B65G 47/24; B29C 49/42065; B29C 49/42095; B65G 37/00; B65G 47/82; B29L 2031/712; B65G 2203/0225; B65G 2203/0233; B65G 2203/0241; B65G 2203/044

(57) ABSTRACT

An apparatus (1) for treating plastic preforms (10) with a receiving device (2), which is suitable and intended for receiving a plurality of plastic preforms (10), with a first transport device (4), which removes the plastic preforms from the receiving device (2) and transports them in a specified transport direction, and with a second transport device (6), which is arranged after the first transport device (4) in the transport direction and which is suitable and intended for transporting the plastic preforms (10) in the transport direction, characterized in that the transport of the plastic preforms (10) by the first transport device (4) can be controlled independently of the transport of the plastic preforms (10) by the second transport device (6).

The present invention relates to an apparatus and a method for treating plastics material preforms. It has long been known from the prior art that plastic preforms are heated in an oven and subsequently formed into plastic containers using a forming device, in particular a stretch blow molding machine. It is also known that different plastic preforms are heated in the oven, for example those that differ in their dimensions.

In addition, it has become known to use plastic preforms with different components, such as, for example, different recycled content. In the case of supply systems for such plastic preforms known from the prior art, different batches of plastic preforms are typically not separated during handling and transport of the plastic preforms and/or sorting, and thus mixing takes place. This mixing ensures that all (even different) plastic preforms are treated in the same way during the production process, for example, they are heated in the same way.

This can have a negative impact on the quality of the resulting containers. It is therefore known from the prior art that in order to ensure the separation of batches or qualities, the system must first be completely emptied and subsequently filled with the next batch. However, this process is very time-consuming.

The previous procedure was sufficient for plastic preforms with different geometries, masses or colors, since changes and adjustments usually have to be made on the downstream machines in parallel with the batch change.

The processing of plastic preform material with a high amount of recycled content leads to comparatively strong fluctuations in the material properties of the plastic preforms compared to the high consistency when using new material.

If batches with different material properties are mixed and supplied into the blow molding machine, it is not able to produce containers of consistent quality, since both the integrated automatic control systems and the construction of the machine do not allow for highly dynamic control. The result is non-compliance with container specifications or, for example, bottle bursting in the blow molding machine.

The present invention is therefore based on the object of providing an apparatus and a method that makes possible a consistent quality of the containers produced. This is achieved according to the invention by the subject matter of the independent claims. Advantageous embodiments and developments are the subject matter of the dependent claims.

An apparatus according to the invention for treating and in particular for transporting plastic preforms has a receiving device that is suitable and intended for receiving a plurality of plastic preforms. In addition, the apparatus has a first transport device that discharges or carries away the plastic preforms from the receiving device and transports them in a specified transport direction. It is possible that this first transport device is directly adjoined to the receiving device, but it would also be conceivable for further devices, such as, in particular, transfer devices, to be arranged between the receiving device and the first transport device. In particular, such a transfer device can be a so-called high conveyor, which preferably transports the plastic preforms upwards at least in a vertical or oblique direction.

However, it would also be possible to transfer the plastic preforms from the receiving device directly to the first transport device. The first transport device, for example, is a conveyor belt.

In addition, a second transport device is provided, which is arranged after the first transport device in the transport direction (of the plastic preforms) and which is suitable and intended for transporting the plastic preforms in the transport direction.

This second transport device is preferably arranged directly after the first transport device, but it would also be possible for a transfer device to be provided between the first transport device and the second transport device, which transfers the plastic preforms from the first transport device to the second transport device.

According to the invention, the transport of the plastic preforms by the first transport device can be controlled and/or performed independently of the transport of the plastic preforms by the second transport device.

In the prior art, such transport devices are typically synchronized and/or coupled to one another. However, within the scope of the invention, an independent control of the transport devices is proposed, in particular to make possible an efficient separation of individual batches of plastic preforms.

Particularly preferably, the first transport device has a first drive device, in particular in the form of an electric motor and in particular in the form of a servo motor. Particularly preferably, the second transport device has a second drive device, also preferably in the form of an electric motor and in particular a servo motor.

Particularly preferably, the first drive device and the second drive device are controllable independently of one another and preferably can be regulate independently of one another.

In a further advantageous embodiment, the receiving device is a reservoir for receiving plastic preforms or a transport unit for transporting plastic preforms. For example, it is possible to pour the plastic preforms directly from the container (such as a so-called octabin) onto a transport device, or into the aforementioned (in particular stationary) reservoir or receiving device.

Particularly preferably, at least one of the transport devices is a transport device that is suitable and intended for receiving a plurality of plastic preforms and in particular also for receiving a plurality of plastic preforms that are not arranged in an oriented manner or are randomly oriented plastic preforms.

In a further preferred embodiment, at least one of the transport devices transports the plastic preforms in a straight line and/or is suitable for this purpose. Preferably, both transport devices transport the plastic preforms in a straight line or are suitable for this purpose in each case.

Particularly preferably, at least one of the transport devices is a transport belt and/or a transport chain. Particularly preferably, both transport devices are conveyor belts or conveyor chains. The transport devices preferably have side guides that in particular prevent the plastic preforms from falling sideways from the transport devices.

In a further advantageous embodiment, the apparatus has a sorting device that is suitable and intended for sorting the plastic preforms supplied to it and, in particular, aligning them in a uniform manner. Sorting is therefore understood to mean sorting in particular with regard to an alignment.

In a further advantageous embodiment, the apparatus has a single-cycle device that transports the plastic preforms and creates a constant division between transported plastic preforms at least in sections. In particular, the single-cycle device is a so-called single-cycle starwheel. The plastic preforms are supplied to these and this single-cycle starwheel typically has a plurality of recesses, which in each case is suitable and intended for receiving a single plastic preform.

Particularly preferably, this single-cycle starwheel or single-cycle device is followed by a heating device for heating the plastic preforms.

In a further advantageous embodiment, the apparatus has a production device for producing plastic preforms. In particular, this is a so-called injection molding machine.

The heating device is particularly preferably an infrared oven, a microwave oven or a laser oven. This heating device preferably has a further transport device that transports the plastic preforms while they are being heated. Particularly preferably, the heating device also comprises a rotating device that rotates the plastic preforms at least temporarily during their heating with respect to their longitudinal direction, in order to achieve uniform heating of the plastic preforms.

Particularly preferably, the apparatus comprises a forming device that is suitable and intended for forming the heated plastic preforms into plastic containers and in particular into plastic bottles. Particularly preferably, this forming device is a stretch blow molding machine.

In a further advantageous embodiment, the sorting device is arranged in the transport device of the plastic preforms at least after the first transport device and preferably after the first and the second transport device.

In a further advantageous embodiment, the sorting device has two rollers arranged parallel to one another, which extend in particular in the transport direction, and between these rollers a gap is formed through which a main body of the plastic preforms can pass, but not a mouth region of the plastic preforms and in particular not a support ring of the plastic preforms. It is particularly preferable for these two rollers to rotate in opposite directions to each other.

A reconfiguration of the logistical processes in the plastic preform supply system is therefore proposed. In this way, mixing of plastic preforms from different containers, for example octabins, during handling and transport and in particular during ongoing production can be completely avoided.

Only in the region of the actual sorting a short-term mixing cannot be avoided, without running the risk of micro-stops at the forming device.

For technical implementation, it is advantageous to control the conveyors or the transport devices of the supply system individually. Frequency converters can be provided for this purpose, for example. Preferably, a frequency converter is assigned to each transport device and in particular to the drive device of each transport device.

In addition, the loading function (using a logic) of a receiving device and the sorting device is preferably adapted and, particularly preferably, a functionality of a return device, for example on the sorting device, is also changed.

The present invention makes it possible to transport small quantities of plastic preforms in the supply, for example, from octabins, in batches with a reasonable amount of effort during the supply process and, preferably, also to sort them in a manner that is nearly batch-pure. In this way, a basic prerequisite is created to achieve consistent container quality with the blow molding machine and the control mechanisms known or currently under development, even with changing properties of the plastic preforms.

In a further preferred embodiment, the apparatus has at least one detection device that is suitable and intended for detecting at least one property that is characteristic of plastic preforms transported by at least one of the transport devices.

Preferably, this property is selected from a group of properties that includes an orientation of the plastic preforms, a number of transported plastic preforms, an occupancy density of the transported plastic preforms, distances between transported plastic preforms, a type of plastic preforms and the like.

Particularly preferably, at least one detection device is assigned to each transport device.

Particularly preferably, at least one detection device is a light barrier device.

Particularly preferably, the apparatus comprises a control device that controls the transport of the plastic preforms using the first transport device and the second transport device. Preferably, this control device is suitable and intended for controlling the transport based on at least one value detected by at least one detection device and in particular based on several values detected by several detection devices. In particular, these values are characteristic of an occupancy state of the transport devices with the plastic preforms.

However, it is also possible that a several light barriers are assigned to one or more transport devices.

In a further advantageous embodiment, the apparatus has a return device that is suitable and intended for returning at least a portion of the plastic preforms and in particular plastic preforms rejected from a discharge device to the transport path of the plastic preforms, in particular upstream of a removal point.

Therefore, the apparatus and in particular the sorting device particularly preferably has a discharge device that is suitable and intended for discharging individual plastic preforms from the transport path, for example to knock them out. These can be, for example, incorrectly oriented plastic preforms.

Particularly preferably, this discharge device is arranged in or after the sorting device.

Particularly preferably, the return device is suitable and intended for supplying such plastic preforms back to the sorting device.

In a further advantageous embodiment, the apparatus has a control device that can control the return device and/or the transport devices in such a way, in particular in such a way that the returned plastic preforms are supplied to a predetermined batch and/or the correct batch (in particular a batch with the same material property).

In a further preferred embodiment, the apparatus has at least one sensor device that is suitable and intended for identifying a type of plastic preform. Preferably, two different types of plastic preforms differ in at least one physical property, for example a recycled content.

Accordingly, the apparatus can be controlled like a forming device. In particular, the drives of said transport devices can also be controlled as a function of this property.

It is therefore proposed to separate batches of plastic preforms, in particular because of different processing in a blow molding machine. When mixing large-volume batches of plastic preforms, strongly differing physical properties of the plastic preforms cannot be compensated by the control mechanisms available in the blow molding machine. This leads to a different bottle quality. The batch separation proposed within the scope of the invention leads to consistent container quality and the control of the blow molding machine can control the process depending on the batch. However, it is assumed that the smallest batch is, for example, a so-called octabin.

On the apparatus side, it is advantageous to provide equipment with a monitoring of the transport devices, for example a belt monitor, when supplying the plastic preforms. As mentioned above, particularly preferably, the individual belt drives can be controlled individually.

Particularly preferably, the first transport device has a transport length that is at least similar to a transport length of the second transport device. Particularly preferably, the lengths of the transport devices or the transport paths over which the plastic preforms travel on the transport devices differ from one another by no more than 30%, preferably no more than 20%, and more preferably no more than 10%.

Preferably, the apparatuses are configured with at least two transport devices, which are in particular two transport belts.

It is therefore proposed that in an apparatus with batch separation, the exchange of supply containers such as octabins is carried out effectively and on a targeted basis. This can be done, for example, using AGVs (automated guided vehicles). When a tipping operation is requested, the silo or a receiving device is preferably already empty. Delays increase the risk of production stoppages, which are also undesirable.

In a further preferred embodiment, it would also be possible to equip such supply devices or tipping devices with an upstream pallet transport.

The present invention is further directed to a method for treating and in particular for transporting plastic preforms and in particular for transporting plastic preforms to a heating device, wherein a plurality of plastic preforms is brought or can be brought (or is conveyed or can be conveyed) to a receiving device that is suitable and intended for receiving a plurality of plastic preforms.

Furthermore, a first transport device transports the plastic preforms away from the receiving device and transports them in a specified transport direction. Furthermore, a second transport device, which is arranged in the transport device after the first transport device and which in particular directly adjoins the first transport device, also transports the plastic preforms in the or in a transport direction.

According to the invention, the transport of the plastic preforms by the first transport device is controlled at least temporarily independently of the transport of the plastic preforms by the second transport device.

Particularly preferably, at least temporarily, a transport speed at which the first transport device transports the plastic preforms is different with respect to a speed at which the second transport device transports the plastic preforms.

Particularly preferably, at least temporarily, one transport device is stopped while the other transport device is moving in each case. Particularly preferably, due to this different control and in particular due to different movement speeds of the transport devices, a separation of different batches of the plastic preforms is made possible.

Particularly preferably, at least two different batches of plastic preforms are transported by the transport devices at least temporarily. Preferably, a gap between these two batches transported by the transport devices is created, enlarged or reduced, in particular due to the corresponding control of the transport devices. It is also possible to keep the size of the gap constant throughout the entire transport.

In a further preferred embodiment, the plastic preforms are sorted and, in particular, aligned in the same way. Particularly preferably, this sorting or alignment is carried out after the transport of the plastic preforms using at least one of the transport devices and particularly preferably after the transport of the plastic preforms using both transport devices.

In a further preferred method, a partial return of plastic preforms is performed. Particularly preferably, plastic preforms are transported from a region or a section that is located after the sorting device in the transport direction to a region or section that is arranged earlier in the transport direction and in particular lies in front of the sorting device.

Plastic preforms that have been discharged from the transport path, in particular in a region of the sorting device, are particularly preferably returned. Plastic preforms that have not been aligned or sorted in a specified manner are particularly preferably sorted out.

Particularly preferably, a discharge of plastic preforms is at least partially carried out. Particularly preferably, discharged plastic preforms are supplied back to the transport path upstream of the sorting device.

In a further preferred method, a gap is formed between the plastic preforms of a first type and the plastic preforms of a second type of plastic preforms. Due to this gap, a batch-pure transport or a batch-pure treatment of the plastic preforms is preferably achieved.

Particularly preferably, this gap is caused by the different control of the transport devices mentioned above. In particular, a transport device, in particular both transport devices, is a conveyor belt or transport belts or transport chains.

A substantial aspect of the invention is thus to avoid mixing of the plastic preforms from different supplied containers (in particular so-called octabins) during ongoing operation. For this purpose, at least two transport devices are provided in front of the sorting device, in particular a roller sorter, wherein the transport devices can be controlled individually.

As mentioned above, preferably a measurement of the loading or occupancy state on the transport devices is carried out, in particular using sensors (e.g., light barriers) and a supply of the new batch, so that a gap is maintained between the batches and no mixing takes place.

As mentioned, a return device is preferably provided, in particular in the form of an intelligent return belt. This return device is provided in particular on the sorting device and in particular on a roller sorter. Preferably, this return device is therefore suitable and intended for transporting the plastic preforms in the opposite direction to the sorting device.

If plastic preforms are discharged from the roller sorter, they are supplied back to the roller sorter via the return device, in particular a return belt.

The apparatus therefore preferably has a discharge device that is suitable and intended for discharging individual plastic preforms from the transport path of the plastic preforms. Preferably, this discharge device is assigned to the sorting device.

The return is preferably carried out in such a way that no mixing with the new batch takes place. For this purpose, a gap can also be created in the (return) flow of plastic preforms in the return device.

An automatic delivery of new supplies containers (in particular octabins) can be advantageously carried out. Robots or AGVs, for example, can be used for this purpose.

As soon as a new batch has arrived at the infeed star or the single-cycle device mentioned above to the oven, the flow of plastic preforms can be stopped. Subsequently, preferably only a few plastic preforms are supplied into the oven in order to determine the appropriate process parameters and/or heating parameters. As soon as the system is stable, production will restart.

Advantageously, the plastic preforms are conveyed directly from an injection molding machine to the oven. For this purpose, an intelligent integration of the transport devices into the entire apparatus is preferably provided.

Preferably, the apparatus comprises at least one inspection device that is suitable and intended for identifying a batch of plastic preforms. This inspection device can, for example, have an image recording device that records one or more images of the transported plastic preforms. Preferably, the plastic preforms can be identified using these images (at least with regard to their type).

Preferably, the apparatus has several of such inspection devices.

Furthermore, it would be conceivable that the formation of the gaps in the flow of plastic preforms does not occur only during transport on the transport devices, but already when the preforms are supplied into the apparatus. The preforms of a first type are tipped onto the first transport device and subsequently the preforms of the second type are tipped at a certain distance. It is possible that the plastic preforms are not first poured into the receiving device, but are poured directly from the octabin onto transport belts or transport devices.

Further advantages and embodiments can be seen in the accompanying drawings, in which:

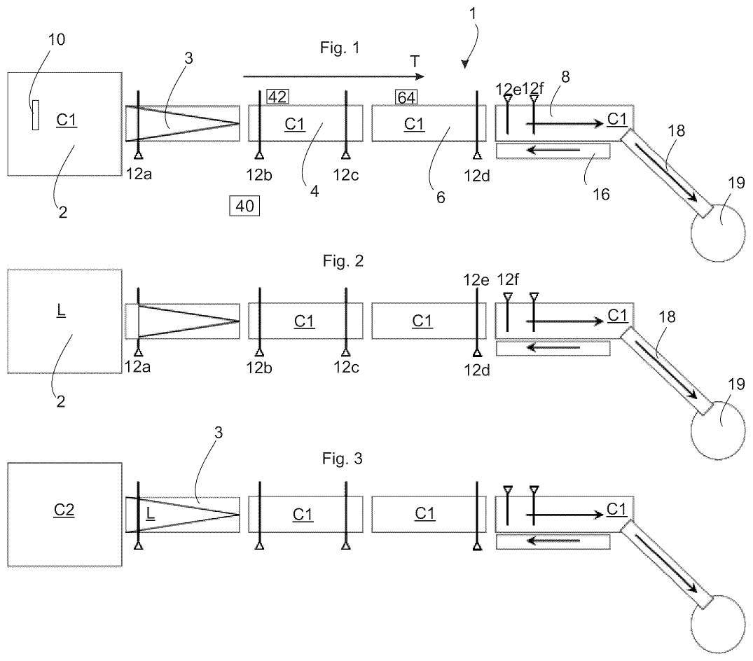

FIG. 1 shows a first representation for illustrating a method according to the invention;

FIG. 2 shows a second method step of the method according to the invention;

FIG. 3 shows a third method step of the method according to the invention;

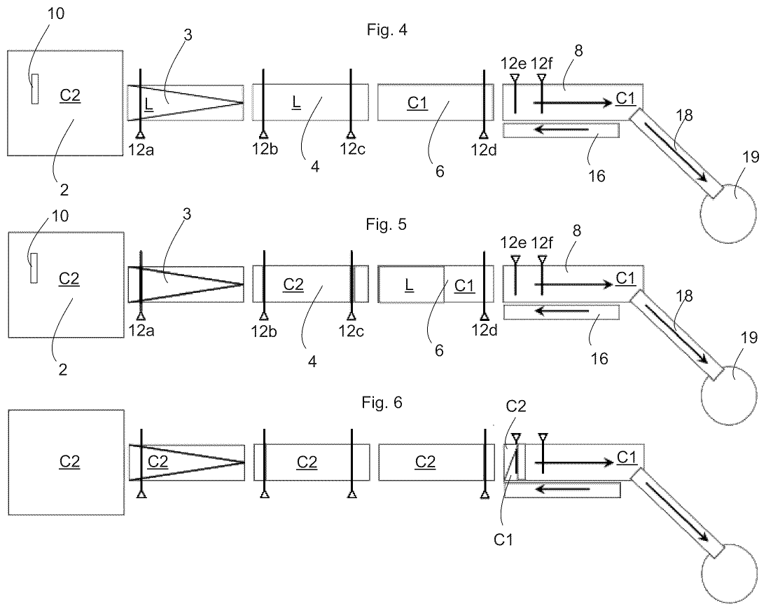

FIG. 4 shows a fourth method step of the method according to the invention;

FIG. 5 shows a fifth method step of the method according to the invention;

FIG. 6 shows a sixth method step of the method according to the invention; and

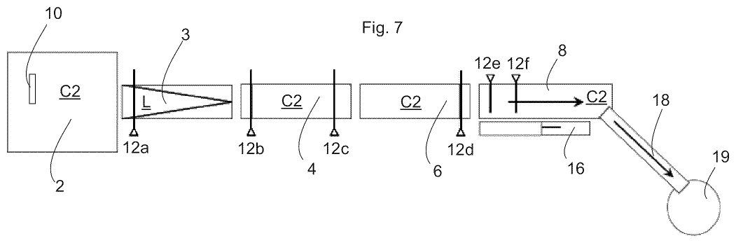

FIG. 7 shows a seventh method step of the method according to the invention;

FIG. 1 shows in its entirety an apparatus 1 according to the invention for treating plastic preforms 10 and in particular for transporting plastic preforms 10. The reference numeral 2 denotes a receiving device that is suitable and intended for receiving (in particular in an unordered manner) a plurality of plastic preforms 10.

These plastic preforms 10 preferably have a main body and a threaded region. This threaded region preferably has a thread and in particular an external thread onto which a closure can be screwed. In addition, these plastic preforms preferably also have a support ring by which they are preferably transported. This support ring protrudes radially beyond the main body of the plastic preforms. The plastic preforms are preferably used for producing plastic containers and in particular plastic bottles.

The reference numeral 4 denotes a first transport device that transports the plastic preforms in sections in a transport direction T, wherein, here, the plastic preforms are preferably transported in a straight line.

The plastic preforms are preferably transferred from the storage device 2 to the first transport device 4 using a transfer device 3. In particular, the transfer device 3 is a vertical conveyor which is preferably also suitable and intended for also lifting plastic preforms in the vertical direction. The transfer device, which is in particular a vertical conveyor or high conveyor, conveys the preforms to a higher level so that a back pressure is generated by gravity when they are later supplied to the oven located further down.

The reference numeral 6 denotes a second transport device, which here adjoins the first transport device 4 and which likewise transports the plastic preforms 10 in the transport direction T.

The reference numeral 42 denotes a drive device of the first transport device and the reference numeral 64 denotes a drive device of the second transport device. These two drive devices 42 and 64 are preferably controllable independently of one another, so that it is possible, for example, that one of the two transport devices moves the plastic preforms while the other transport device is stationary.

The reference numeral 8 denotes a sorting device that is suitable and intended for sorting the plastic preforms and in particular aligning them uniformly.

The reference numeral 16 denotes a return device that serves, for example, to return incorrectly sorted and in particular incorrectly oriented plastic preforms, in particular to a position upstream of the sorting device 8.

The reference numeral 18 denotes a conveyor device that serves to guide the plastic preforms, in particular one after the other, to a single-cycle device such as a single-cycle starwheel 19. This single-cycle starwheel 19 is preferably followed by a heating device (not shown) for heating the plastic preforms. In particular, this is an infrared oven or a microwave oven or laser oven.

The reference numerals 12a-12f denote a plurality of detection devices that can detect, for example, an occupancy state or loading state in the individual transport sections of the transport path with plastic preforms.

Preferably, at least one such detection device is assigned to each of the individual units of the apparatus. Preferably, two such detection devices (12b and 12c) are also assigned to at least one transport device and in particular to the first transport device 4.

Preferably, at least one of these transport devices and in particular several of these transport devices are light barriers.

The reference numeral 40 denotes a control device for controlling the apparatus and in particular also for controlling the transport devices 4 and 6 and in particular their drive devices 42 and 64. Preferably, signals and/or measured values of the individual detection devices 12a-12f are also supplied to the control device and the control device controls the transport devices 4, 6 also taking these signals into account, in particular in order to perform a batch change.

The following FIGS. 2-9 describe the method for performing a batch change. In the situation shown in FIG. 1, the apparatus is still fully loaded with plastic preforms of a first batch C1 (lighter shade of gray).

In the situation shown in FIG. 2, the receiving device 2 has been emptied (L), i.e., there are no more plastic preforms in this receiving device 2. All other parts of the apparatus still contain the plastic preforms from batch C1.

In the situation shown in FIG. 3, plastic preforms of a second batch C2 were filled into the receiving device (darker shade of gray). Furthermore, in this state, the transfer device 3 (which is in particular a vertical conveyor) was emptied (L). The remaining parts of the apparatus still contain the plastic preforms of the first batch C1.

In the situation shown in FIG. 4, the plastic preforms of the second batch C2 are still retained in the receiving device 2 and the first transport device 4 is also empty. The plastic preforms of the first batch C1 are still located in the second transport device 6 and the further devices of the apparatus. In this way, a gap was formed between the plastic preforms of the first batch C1 and the plastic preforms of the second batch C2.

In the situation shown in FIG. 5, the transport of the plastic preforms of the second batch C2 has now also been released and these are now also located in the transfer device 3 and in a region of the first transport device. A region of the first transport device 4 and a region of the second transport device 6 are empty or there is a gap here.

The remaining regions of the second transport device 6 and the subsequent devices still contain the plastic preforms of the first batch C1. However, the gap between the first batch C1 and the second batch C2 was reduced again, which is possible in particular through the independent control of the two transport devices 4 and 6.

In the situation shown in FIG. 6, the second transport device 6 now also contains exclusively plastic preforms of the second batch C2. The gap between the two batches C1, C2 was further reduced.

Within the sorting device 8, there is a small region in which both plastic preforms of the first batch C1 and plastic preforms of the second batch C2 can be located.

In the situation shown in FIG. 7, the sorting device 8 is now also completely loaded with plastic preforms of batch C2. A gap no longer occurs in the return device 12. In the devices 18 and 19 following the sorting device 8, the plastic preforms from the first batch C1 are still present.

It is to be noted that all features which have been described with reference to the method are also disclosed in a corresponding manner for the apparatus, which means in particular that the corresponding apparatus has devices which are suitable and intended for carrying out the particular methods. Furthermore, features which were described with reference to the apparatus are also correspondingly applicable to the method or methods. This means that the methods are carried out using the corresponding apparatus features.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different figures.

1. An apparatus for treating plastic preforms with a receiving device, which is suitable and intended for receiving a plurality of plastic preforms, with a first transport device, which removes the plastic preforms from the receiving device and transports them in a specified transport direction and with a second transport device, which is arranged after the first transport device in the transport direction and which is suitable and intended for transporting the plastic preforms in the transport direction,
characterized in that
the transport of the plastic preforms by the first transport device can be controlled independently of the transport of the plastic preforms by the second transport device.

2. The apparatus according to claim 1,
characterized in that
the receiving device is a reservoir for receiving plastic preforms or a transport unit for transporting plastic preforms.

3. The apparatus according to claim 1,
characterized in that
at least one of the transport devices transports the plastic preforms in a straight line.

4. The apparatus according to claim 1,
characterized in that
the apparatus has a sorting device that is suitable and intended for sorting the plastic preforms supplied to it.

5. The apparatus according to claim 4,
characterized in that
this sorting device is arranged at least after the first transport device in the transport direction of the plastic preforms.

6. The apparatus according to claim 4,
characterized in that
the sorting device has two rollers arranged parallel to one another, which extend in the transport direction, and between these rollers a gap is formed through which a main body of the plastic preforms can pass, but not a mouth region of the plastic preforms.

7. The apparatus according to claim 1,
characterized in that
the apparatus has at least one detection device that is suitable and intended for detecting at least one property that is characteristic of plastic preforms transported by at least one transport device, wherein this property is preferably selected from a group of properties that include an orientation of the plastic preforms, a number of transported plastic preforms, a density of the transported plastic preforms or distances between transported plastic preforms.

8. The apparatus according to claim 7,
characterized in that
each transport device is assigned at least one detection device.

9. The apparatus according to claim 7,
characterized in that
at least one detection device is a light barrier device.

10. The apparatus according to claim 1,
characterized in that
the apparatus comprises a return device that is suitable and intended for returning at least a portion of the plastic preforms to the transport path of the plastic preforms upstream of a removal point.

11. The apparatus according to claim 1,
characterized in that
the apparatus has at least one sensor device that is suitable for identifying a type of plastic preform.

12. A method for treating plastic preforms, wherein a plurality of plastic preforms are conveyed to a receiving device that is suitable and intended for receiving a plurality of plastic preforms, and wherein a first transport device removes the plastic preforms and transports them in a specified transport direction and wherein a second transport device, which is arranged after the first transport device in the transport direction, transports the plastic preforms in the transport direction,
characterized in that
the transport of the plastic preforms by the first transport device is controlled at least temporarily independently of the transport of the plastic preforms by the second transport device.

13. The method according to claim 12,
characterized in that
the plastic preforms are sorted.

14. The method according to claim 12,
characterized in that
a return of the plastic preforms is at least partially carried out.

15. The method according to claim 12,
characterized in that
a gap is formed between the plastic preforms of a first type and the plastic preforms of a second type.
